(19) United States
(12) Patent Application Publication
(10) Pub. No.: US 2025/0180772 A1
(43) Pub. Date: Jun. 5, 2025

(54) LOGGING TOOL CHANNEL PRIORITIZATION

(71) Applicant: Schlumberger Technology Corporation, Sugar Land, TX (US)

(72) Inventors: Keli Sun, Sugar Land, TX (US); Hui Xie, Katy, TX (US); Xiaoyan Zhong, Sugar Land, TX (US); Kong Hauw Sarwa Bakti Tan, Sugar Land, TX (US); Ettore Mirto, Petaling Jaya (MY); Kent Harms, Richmond, TX (US)

(21) Appl. No.: 18/527,686

(22) Filed: Dec. 4, 2023

(51) Int. Cl. G01V 3/38; G01V 3/30; G01V 3/34

(52) U.S. Cl. CPC G01V 3/38; G01V 3/30; G01V 3/34

(57) ABSTRACT

Techniques and systems for logging tool data channel prioritization. A system includes a logging tool configured to generate measurements in a well during a drilling operation and transmit a predetermined portion of the measurements and a processing system configured to be coupled to the logging tool, wherein the processing system is configured to calculate which data channels of the logging tool to prioritize as the predetermined portion of the measurements to transmit and transmit a control signal to configure the logging tool to transmit the predetermined portion of the measurements.

### BACKGROUND

The subject matter disclosed herein relates to systems and methods of data channel selection and prioritization, particularly for use with well logging tools.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Producing hydrocarbons from a wellbore drilled into a geological region is a remarkably complex endeavor. In many cases, decisions involved in hydrocarbon exploration and production may be informed by measurements from downhole well-logging tools that are conveyed deep into the wellbore. The measurements may be used to infer properties or characteristics of the geological region surrounding the wellbore.

Well logging tools, such as downhole tools, are utilized to measure well properties for well evaluation. These logging tools can include, for example, electromagnetic logging tools. The logging tools are typically utilized in conjunction with logging-while-drilling (LWD) operations or mapping-while-drilling operations in which formation evaluation measurements (e.g., resistivity, porosity, etc.) are taken during drilling operations. These measurements can be useful in providing, for example, bed boundary detection as well as delineation of reservoir boundaries and fluid contacts in a formation. However, as the logging tools become more accurate, the amount of data that they transmit also increases.

### BRIEF DESCRIPTION OF THE DRAWINGS

Various aspects of this disclosure may be better understood upon reading the following detailed description and upon reference to the drawings in which:

FIG. 1 depicts an example wellsite system for measuring borehole data using various downhole tools and surface tools, in accordance with embodiments of the present disclosure;

FIG. 2 depicts a well control system configured to control the wellsite system of FIG. 1, in accordance with embodiments of the present disclosure;

FIG. 3 depicts an example of an electromagnetic logging tool as the logging tool of FIG. 1, in accordance with embodiments of the present disclosure;

FIG. 4 depicts a flow chart describing a technique to reduce implement channel selection for transmission of data measured by the electromagnetic logging tool of FIG. 3, in accordance with embodiments of the present disclosure;

FIG. 5 depicts a plot of a first data resolution matrix inclusive of the measurement channels of the electromagnetic logging tool of FIG. 3, in accordance with embodiments of the present disclosure; and

FIG. 6 depicts a plot of a second data resolution matrix inclusive of the measurement channels of the electromagnetic logging tool to be transmitted to the processing system of FIG. 2, in accordance with embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Downhole tools, for example, electromagnetic (EM) logging tools have grown more sophisticated. For example, EM logging tools are capable of providing advanced downhole measurements, which produces a large number of measurement logs. However, with their increased measurement capabilities, there has been an increase in the amount of information that the downhole tools, for example, logging tools transmit. These can exceed telemetry limits, making it difficult to transmit all the measurements to the surface in a timely manner. Thus, telemetry has increasingly become a bottleneck for logging-while-drilling operations or mapping-while-drilling operations, since current telemetry techniques only have enough bandwidth to transmit a fraction of downhole measured data.

EM logging tools are typically set to transmit a full set of measurements that are designed to cover arbitrary scenarios. However, the EM logging tool does not experience all of these scenarios at the same time. Thus, for a given scenario (i.e., a stage in the logging-while-drilling (LWD) operation or the mapping-while-drilling operation), a portion of logs may have less importance. For an example, long spacing and high frequency measurement in conductive formation are useless due to low signal to noise level. Present embodiments are directed to the identification of relevant portions of measurements and their transmission, including techniques to select the most important and informative measurement channels to be sent to the surface. By applying a prioritization operation prior to transmission of measured data, the telemetry limitations of the system can be managed while still providing measurements deemed to have the most importance and least redundancy, while maintaining the number of channels at or below telemetry capacity.

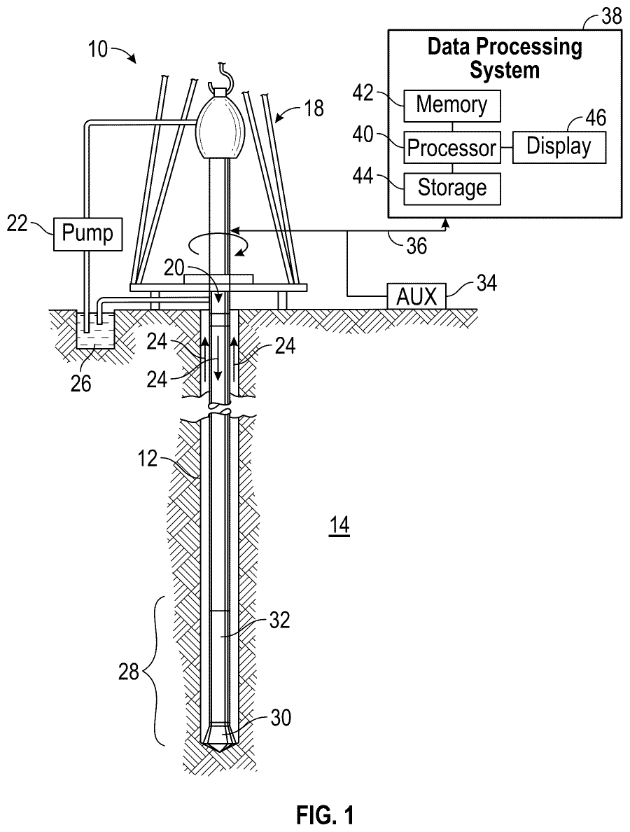

With the foregoing in mind, FIG. 1 illustrates a drilling system 10 that may employ the systems and methods of this disclosure. The drilling system 10 may be used to drill a borehole 12 into a geological region 14. In the drilling system 10, a drilling rig 18 may rotate a drill string 20 within the borehole 12. As the drill string 20 is rotated, a drilling fluid pump 22 may be used to pump drilling fluid, which may be referred to as “mud” or “drilling mud,” downward through the center of the drill string 20, and back up around the drill string 20, as shown by reference arrows 24. At the surface, return drilling fluid may be filtered and conveyed back to a mud pit 26 for reuse. The drilling fluid may travel down to the bottom of the drill string 20 known as the bottom-hole assembly (BHA) 28. The drilling fluid may be used to rotate, cool, and/or lubricate a drill bit 30 that may be a part of the BHA 28. The fluid may exit the drill string 20 through the drill bit 30 and carry drill cuttings away from the bottom of the borehole 12 back to the surface.

The BHA 28 may include the drill bit 30 along with various downhole tools, such as one or more logging tools 32. The BHA 28 may thus convey the one or more logging tools 32 through the geological region 14 via the borehole 12. As described in greater detail herein, the one or more logging tools 32 may be any suitable downhole tool that emits electromagnetic waves within the borehole 12 (e.g., a downhole environment). The downhole tools, which may include the one or more logging tools 32, may collect a variety of information relating to the geological region 14 and the state of drilling in the borehole 12. For instance, the downhole tools may be logging—while drilling (LWD) tools that measure physical properties of the geological region 14, such as density, porosity, resistivity, lithology, and so forth. Likewise, the downhole tools may be measurement-while-drilling (MWD) tools that measures certain drilling parameters, such as the temperature, pressure, orientation of the drill bit 30, mapping-while-drilling tools, and so forth.

The one or more logging tools 32 may receive energy from an electrical energy device or an electrical energy storage device, such as an auxiliary power source 34 or another electrical energy source to power the tool. In some embodiments, the one or more logging tools 32 may include a power source within the one or more logging tools 32, such as a battery system or a capacitor, to store sufficient electrical energy to emit and/or receive electromagnetic waves.

Communications 36, such as control signals, may be transmitted from a data processing system 38 (processing system 38) to the one or more logging tools 32, and communications 36, such as data signals related to the results/measurements of the one or more logging tools 32, may be returned to the data processing system 38 from the one or more logging tools 32. The data processing system 38 may be any electronic data processing system that can be used to carry out the systems and methods of this disclosure. For example, the data processing system 38 may include one or more processors 40, which may execute instructions stored in memory 42 and/or storage 44. The memory 42 and/or the storage 44 of the data processing system 38 may be any suitable article of manufacture that can store the instructions. In certain embodiments, the one or more processors 40 may include a microprocessor, a microcontroller, a processor module or subsystem, a programmable integrated circuit, a programmable gate array, a digital signal processor (DSP), or another control or computing device. In certain embodiments, the one or more processors 40 may include machine learning and/or artificial intelligence (AI) based processors.

In certain embodiments, the memory 42 and storage 44 is implemented as one or more non-transitory computer-readable or machine-readable storage media. In certain embodiments, the memory 42 may include one or more different forms of memory, including semiconductor memory devices such as dynamic or static random access memories (DRAMs or SRAMs), erasable and programmable read-only memories (EPROMs), electrically erasable and programmable read-only memories (EEPROMs) and flash memories. The storage 44 may include solid state drives, magnetic disks such as fixed, floppy and removable disks; other magnetic media including tape; optical media such as compact disks (CDs) or digital video disks (DVDs); or other types of storage devices. Note that the computer-executable instructions and associated data of the analysis module(s) may be provided on one computer-readable or machine-readable storage medium of the memory 42 or the storage 44, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the storage 44 may be located either in the machine running the machine-readable instructions or may be located at a remote site from which machine-readable instructions may be downloaded over a network for execution.

As illustrated, the data processing system 38 may optionally also include a display 46, which may be any suitable electronic display, may display images generated by the processor 40. The data processing system 38 may be a local component of the drilling system 10 (i.e., at the surface), within the one or more logging tools 32 (i.e., downhole), a device located proximate to the drilling operation, and/or a remote data processing device located away from the drilling system 10 to process downhole measurements in real time or sometime after the data has been collected. In some embodiments, the data processing system 38 may be a portable computing device (e.g., tablet, smart phone, or laptop) or a server remote from the drilling system 10. In some embodiments, the one or more logging tools 32 may store and process collected data in the BHA 28 or send the data to the surface for processing via communications 36 described above, including any suitable telemetry (e.g., electrical signals pulsed through the geological region 14 or mud pulse telemetry using the drilling fluid).

It should be noted that, although the discussion above relates to a drilling system, other downhole equipment or systems may employ the systems and methods of this disclosure. For example, a downhole tool with an acoustic tool conveyed by slickline, coiled tubing, wireline, or other delivery systems, may utilize the disclosed systems and methods.

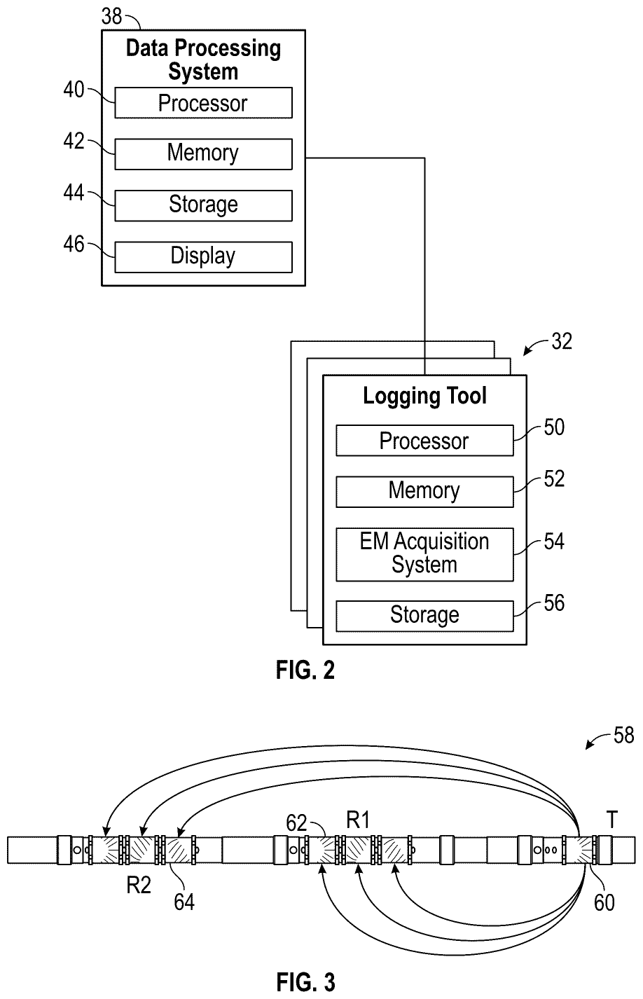

Operation of drilling system 10 may be controlled by a processor of the data processing system 38. For example, FIG. 2 illustrates a block diagram of the data processing system 38 that is communicatively coupled to the one or more logging tools 32. In the illustrated embodiment, a logging tool 32 includes a processor 50, memory 52, an electromagnetic (EM) acquisition system 54, and storage 56. In some embodiments, the processor 50 may be ASIC (application specific integrated circuit), field programmable gate array (FPGA), a micro control unit (MCU), a digital signal processor (DSP), and the like. In general, the drilling system 10 communicates with the data processing system 38 via a data cable, telemeter or other suitable techniques. For example, the drilling system 10 may communicate EM measurements obtained by an EM sensor (or meter) as part of the EM acquisition system 54. In turn, a processor of the surface control system may determine certain parameters (e.g., porosity, water saturation, permeability, velocities, resistivity, and so forth) based on the EM measurements. In such embodiments, the EM acquisition system 54 may include an emission source (e.g., an antenna) to acquire, obtain, or otherwise measure EM measurements.

In certain embodiments, the data processing system 38 may include one or more analysis modules (e.g., a program of computer-executable instructions and associated data) that may be configured to perform various functions of the embodiments described herein. In certain embodiments, to perform these various functions, the one or more analysis modules may executed on one or more processors 40 of the processing system 38, which may be connected to memory 42 and storage 44 in which the one or more analysis modules may be stored.

In certain embodiments, the computer-executable instructions of the one or more analysis modules, when executed by the one or more processors 40, may cause the one or more processors 40 to generate one or more models (e.g., forward model, inverse model, mechanical model, and so forth). Such models may be used by the processing system 38 to predict values of operational parameters that may or may not be measured (e.g., using gauges, sensors, and so forth) during well operations.

FIG. 3 illustrates an example of an electromagnetic (EM) logging tool 58 that can be utilized as one of the one or more logging tools 32. The EM logging tool 58 (e.g., EM tool 58), as illustrated, includes one or more coils (e.g., co-axial coils) as a transmitter 60 as well as receiver 62 and receiver 64 disposed along the EM tool 58. One or both of the receiver 62 and the receiver 64 can include tilted and/or transverse and/or axial coils (e.g., antenna). This results in mapping-while-drilling or LWD services that provide rapid and high delineation of reservoir layers and formation evaluation while drilling.

During operation, downhole measurements made by the EM tool 58 produce a large amount of measurement logs. These can easily exceed telemetry limits, making it impractical to send all the measurements to the surface in real time or near real time for processing. This can create issues for LWD or mapping while drilling operations. Typically, the EM tool 58 is designed to cover many (or all) expected scenarios for any given operation. The tool 58 provides the full set of measurements to ensure that sufficient and sensitive measurements are available in each of the arbitrary scenarios envisioned. However, for a given scenario experienced at a given time during operation, at least a portion of logs may not be critical to perform the LWD or mapping while drilling operation. For an example, long spacing and high frequency measurements made in conductive formations have low value, since they have a low signal to noise level and, thus, are typically discarded during processing.

In some embodiments, instead of transmitting logs having reduced processing value during a portion of an operation of the EM tool 58, the EM tool 58 can be setup or otherwise configured to omit transmission of these logs and to instead prioritize logs deemed to have greater value for that particular portion of the operation. Thus, the EM tool 58 can be setup to transmit a portion of collected measurements that coincide with a particular stage of LWD or mapping while drilling operations. In another stage of the operation, a different portion of the collected measurements can be prioritized for transmission. In this manner, the most relevant measurements for any given stage of an LWD or mapping while drilling operation are transmitted, which reduces the total amount of logs being transmitted at any given time and, accordingly, is able to operate without exceeding telemetry limits. Additionally, in some embodiments, multiple predetermined portions of measurements can be collected. For example, the one or more logging tools 32 can be setup (or otherwise configured) to collect more than one set of predetermined portions of measurements. Additionally, a downlink can be established to switch between the multiple predetermined sets of measurements. This can be useful, for example, in conjunction with multiple cases (1D, 2D, even 3D). Furthermore, in some embodiments, the selection of portions of measurements can be performed in real-time, i.e., during drilling either at the surface (e.g., using the data processing system 38) or downhole (e.g., using a logging tool 32).

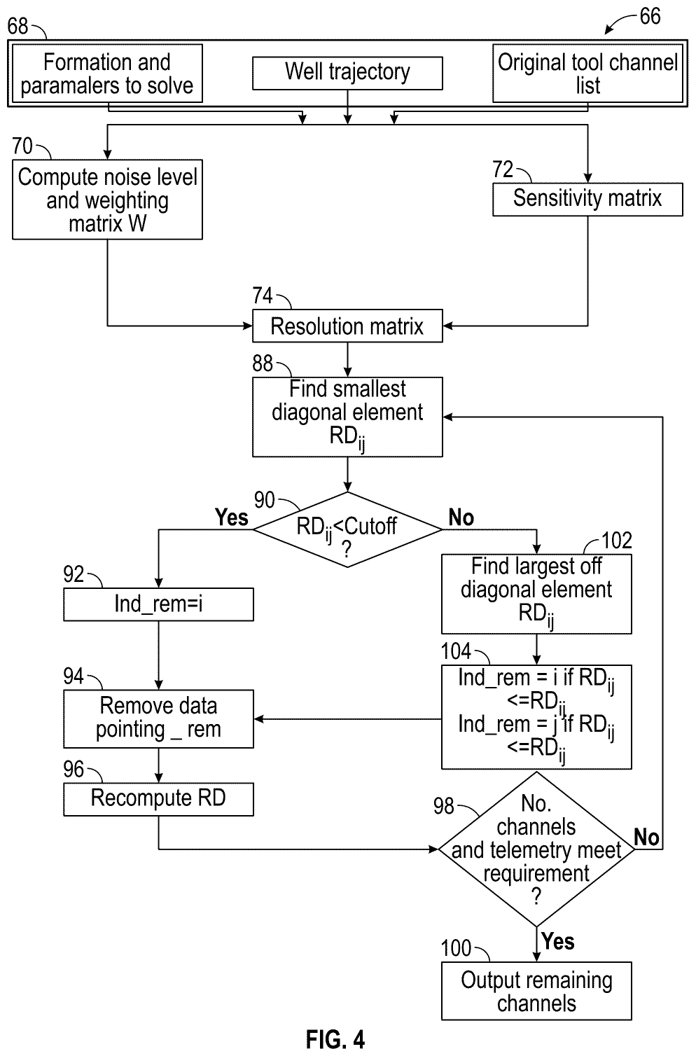

FIG. 4 depicts a flow chart 66 describing a first technique to implement channel selection and/or prioritization for transmission of data measured by a logging tool, for example, the EM logging tool 58. Although, it should be noted that other logging tools can instead be utilized to generate measurements (e.g., sonic, nuclear, etc.). It should be noted that one or more of the blocks of flow chart 66 may be performed by the processing system 38 (e.g., via the one or more processors 40 executing code stored in the one or more of the memory 42 or the storage 44). Additionally, one or more of the blocks of flow chart 66 can be performed by the processor 50 in conjunction with the memory 52 or storage 56. Furthermore, the blocks of flow chart 66 need not be performed in the illustrated order and one or more of the blocks may be selectively omitted.

In block 68 of FIG. 4, stored input values may be transmitted to (or received by), for example, the one or more processors 40 of the data processing system 38. These input values can include, formation characteristics and/or parameters to be solved in conjunction with the LWD or mapping-while-drilling operation. The input values can also include, for example, well trajectory information (i.e., depths, angles, and/or other characteristics of the well being drilled). The input values can also include, for example, a tool channel list that represents all of the channels for measurement logs that can be transmitted by the EM tool 58. The input values can include more or fewer than the illustrated example input values and the input values of block 68 can be part of (or can be combined in block 68 into) a pre-job formation model that will allow for modeling of responses, analysis of log uncertainty and sensitivity, and automatic sort out of desired logs to be transmitted during the operation.

For a known formation model and parameters to solve, together with the planned well path, from block 68, in block 70 and in block 72, tool responses can be computed both with noise (block 70) and without noise (block 72). This will allow for the computation of measurement noise level and measurement uncertainties.

In block 70, the noise level for the channel can be determined, computed, or modeled. This can represent the amount of noise expected to be encountered when receiving data along the channel list on the surface, e.g., to the data processing system 38. Additionally, based on the noise level computed, a weighting matrix (W) can be generated in block 70. For example, assuming d=[d₁ d₂ . . . dₙ]^{T} is the measurement logs (i.e., the measurement signals generated by the EM tool 58) and m=[x₁ x₂ . . . xₘ]^{T} are model parameters (e.g., the modeled resistivity of the layers of the formation being measured, the modeled boundaries of the formation, etc.) of, for example, an earth model corresponding to the formation being measured, then data weighting in the inversion are defined based on measurement noise level

$$W = diag [ \begin{matrix}{w}_{1} & {w}_{2} & … & {w}_{n}\end{matrix} ] = diag [ \begin{matrix}\frac{1}{{δ}_{1}} & \frac{1}{{δ}_{2}} & … & \frac{1}{{δ}_{n}}\end{matrix} ] ,$$

where δ are the measurement noise levels. Additionally, in block 72, a sensitivity matrix can be obtained by computing noise free responses with perturbed formation parameters. This sensitivity matrix can be, for example, a Jacobian matrix, which can be computed as, for example,

$${J}_{W} = JW or {J}_{{W}_{ij}} = \frac{\partial ( {d}_{i} {w}_{i} )}{\partial {x}_{j}} .$$

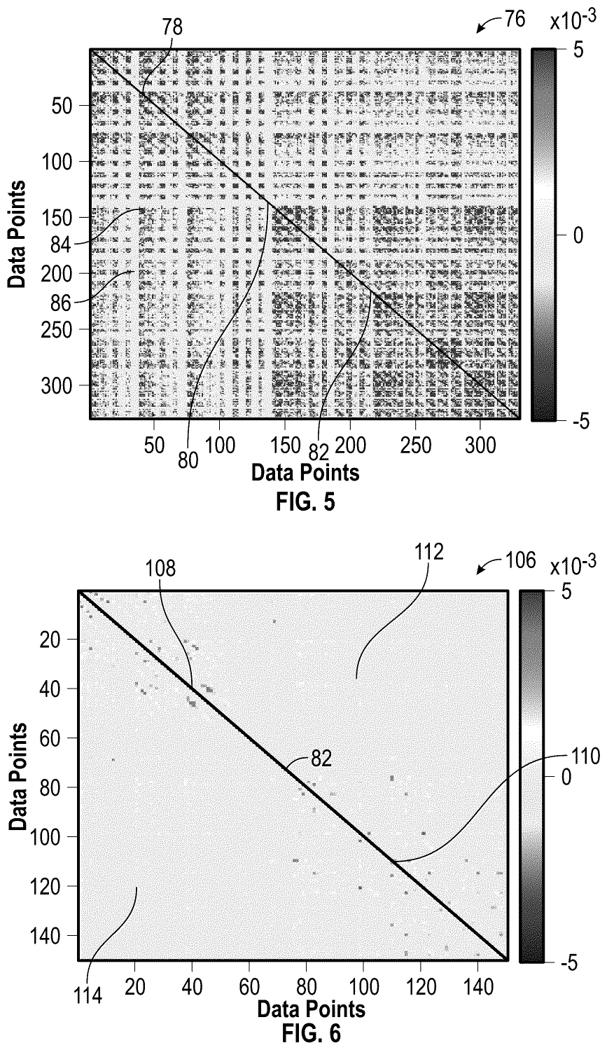

The results of block 70 (i.e., a weighting matrix) can be combined with the results of block 72 (i.e., a sensitivity matrix) for generation of a resolution matrix in block 74 as R^{data}=J_{W}((J_{W})^{T} J_{W}+λWₓ^{T}Wₓ)⁻¹ (J_{W})^{T}. One example of a data resolution matrix is illustrated in conjunction with FIG. 5. FIG. 5 illustrates a plot 76 of an example of a data resolution matrix calculated in conjunction with block 74 representing channel “i” and channel “j”. As illustrated, the data resolution matrix has a resolution corresponding to 360 data channels. However, this number of channels can vary, for example, based on the type of EM tool 58 utilized.

The shading present in the plot 76 coincides with the value of matrix elements, whereby the darker shaded matrix elements, for example, at location 78, represent a greater value than lighter shaded matrix elements, for example, at location 80. As illustrated, the magnitude of diagonal elements (i.e., Rᵢᵢ^{data}), represented by the darker shading along the diagonal 82, indicate the relative importance of a corresponding data point in the plot 76. Thus, the data channel at location 78 in plot 76 is deemed to have a greater importance than the data channel at location 80.

Furthermore, the off-diagonal elements (i.e., Rᵢⱼ^{data}) can indicate a correlation between channel i and channel j. That is, off-diagonal portions of the data resolution matrix with the greatest amount of correlation represent the greatest amount of redundancy between channel i and j, i.e., channel i and j provide same information, such that adding the data from channel j in addition to the data from channel i doesn't create any additional value in the data transmitted from the EM tool 58. As illustrated in the plot 76, the darker shaded matrix elements, for example, at location 84 represent a greater amount of redundancy than that present at location 86.

Thus, the data resolution matrix can operate as a guide in selecting the channels along the diagonal 82 with the greatest importance (e.g., the channel at location 78 and not the channel at location 80). The data resolution matrix can also operate to identify channels with collisions (i.e., redundant data being transmitted), resulting in their darker in off-diagonal regions of the data resolution matrix (e.g., location 84) so that the identified channels can be omitted from having their data transmitted. Thus, for channel selection, the data resolution matrix is useful in identifying channels along the diagonal 82 with the highest importance while also identifying redundant off-diagonal channels so that the resultant channels selected represent high importance diagonal 82 elements and low (e.g., zero or a small value) off diagonal elements (so that redundancy of the off-diagonal channels is minimized). These techniques can be performed in conjunction with the remaining blocks of flow chart 66 of FIG. 4.

In block 88 of FIG. 4, the smallest diagonal element of the resolution matrix generated in block 74 is determined. For example, the data point along diagonal 82 of the data resolution matrix of FIG. 5 having the smallest value (i.e., corresponding to the least amount of shading) is determined and selected. This selected data point is compared against a predetermined threshold value (i.e., the value of the selected data point from block 88 is compared to a cutoff value) in block 90. If the selected data point is determined to be less than the predetermined threshold value in block 90, then, in block 92, the channel corresponding to the selected data point is identified (i.e., an index of the channel to be removed) and in block 94, the identified channel is removed (e.g., the channel corresponding to the selected data point is filtered or disabled so that its measurement log will not be transmitted). This can also correspond to the data point being removed from both the sensitivity matrix and the weighting matrix as part of block 94.

Thereafter, in block 96, the resolution matrix is recomputed using the modified sensitivity matrix and the weighting matrix (i.e., the sensitivity matrix and the weighting matrix each having the data point from block 92 removed therefrom). In block 98, telemetry requirements for the EM tool 58 are reviewed (e.g., via the data processing system 38, for example, via the one or more processors 40 executing code stored in the memory 42 and/or storage 44) for the recomputed resolution matrix to determine whether the recomputed resolution matrix from block 96 has a reduced number of channels that meet a transmission threshold value for the EM tool 58 (e.g., whether the recomputed resolution matrix has a number of channels and telemetry requirements that meet a predetermined level for transmission by the EM tool 58. If the recomputed resolution matrix from block 96 meets the requirements in block 98, the data corresponding to the channels of the recomputed resolution matrix will be transmitted in conjunction with block 100.

If, however, the recomputed resolution matrix from block 96 does not meet the requirements in block 98 (i.e., if the channels and/or the data therein to be transmitted exceed a set telemetry threshold) the process returns to block 88 and the smallest (remaining) diagonal element of the resolution matrix (i.e., the recomputed resolution matrix from block 96) is determined. The process follows the same blocks as long as the iteratively recomputed resolution matrix from block 96 continues to have an excess of data channels for transmission (i.e., does not meet the requirements in block 98).

The above described iterative process operates to find channel(s) corresponding to small diagonal elements and to remove the channels if they are smaller than a predetermined cutoff value (in block 90). However, in some situations, this process will not alone remove enough data channels to meet the transmission requirements of block 98. For example, if the smallest diagonal element of the recomputed (or original) resolution matrix from block 88 is not less than the cutoff value in block 90, additional channels from the off-diagonal channels of the recomputed (or original) resolution matrix will be removed. This process begins in block 102 (subsequent to the smallest diagonal element of the recomputed (or original) resolution matrix from block 88 not being less than the cutoff value in block 90). In block 102, channel i and channel j corresponding to the largest off-diagonal term RDᵢⱼ are found. In block 104 if channel i has less than or equal importance (e.g., less or the same shading) as channel j, then the data channel from channel i is determined to be removed. If instead, in block 104, if channel i has larger importance (e.g., more shading) than channel j, then than the data channel from channel j is determined to be removed. In this manner, blocks 102 and 104 operate to determine the two channels corresponding the largest off-diagonal elements and to determine which of these channels have the smaller importance. In block 94, the channel with the lesser importance (e.g., the off-diagonal channel corresponding to the lesser importance from block 104) is subsequently removed. This can also correspond to the data point being removed from both the sensitivity matrix and the weighting matrix as part of block 94.

Thereafter, in block 96, the resolution matrix is recomputed using the modified sensitivity matrix and the weighting matrix (i.e., the sensitivity matrix and the weighting matrix each having the data point or data channel from block 104 removed therefrom). In block 98, telemetry requirements for the EM tool 58 are reviewed (e.g., via the data processing system 38, for example, via the one or more processors 40 executing code stored in the memory 42 and/or storage 44) for the recomputed resolution matrix to determine whether the recomputed resolution matrix from block 96 has a reduced number of channels that meet a transmission threshold value for the EM tool 58 (e.g., whether the recomputed resolution matrix has a number of channels and telemetry requirements that meet a predetermined level for transmission by the EM tool 58. If the recomputed resolution matrix from block 96 meets the requirements in block 98, the data corresponding to the channels of the recomputed resolution matrix will be transmitted in conjunction with block 100.

If, however, the recomputed resolution matrix from block 96 does not meet the requirements in block 98 (i.e., if the channels and/or the data therein to be transmitted exceed a set telemetry threshold) the process returns to block 88. The smallest (remaining) diagonal element of the resolution matrix (i.e., the recomputed resolution matrix from block 96) is determined and as it is greater than the cutoff value in block 90, the process of off-diagonal data channel removal is repeated (via blocks 102, 104, and 94) in the manner described above. The process follows the same blocks as long as the iteratively recomputed resolution matrix from block 96 continues to have an excess of data channels for transmission (i.e., does not meet the requirements in block 98).

When sufficient diagonal elements or when sufficient diagonal elements and off-diagonal elements have been removed, the process will end in block 100, whereby the data corresponding to the channels of the recomputed resolution matrix will be transmitted in conjunction with block 100, whereby the data corresponding to the channels of the recomputed resolution matrix will be transmitted.

FIG. 6 illustrates an example of a data resolution matrix corresponding to the data transmitted in block 100 generated based upon the resolution matrix of FIG. 5 having undergone the data channel reduction technique described above. FIG. 6 illustrates a plot 106 of an example of a data resolution matrix calculated in conjunction with blocks 88-104 described above. As illustrated, the data resolution matrix of FIG. 6 has a resolution corresponding to 150 data channels, as compared to the resolution of 360 data channels in the data resolution matrix of FIG. 5. However, this number of channels can vary, for example, based on the telemetry requirements of a given system.

As illustrates in plot 106, the darker shaded matrix elements (e.g., more important) are generally located about the diagonal 82, for example, at location 108 and location 110 while the lighter shaded matrix elements (lesser importance) are located in off-diagonal regions of the data resolution matrix, for example, at location 112 and location 114. In this manner, the plot 106 of the data resolution matrix. Thus, not only are the number of channels to be transmitted from the data resolution matrix of FIG. 6 reduced relative to the number of channels to be transmitted from the data resolution matrix of FIG. 5, the channels to be transmitted correspond to the prioritized channels (e.g., most important along the diagonal 82 and the least redundant off-diagonal channels).

It should be noted that the process outlined above can be setup as a prejob configuration of the EM tool 58. Accordingly, for various portions of the formation, a separate process can be generated so that at various times and depths, the data channels may differ. That is for a given formation model, the response can be forward modeled to predict analysis log uncertainty and sensitivity, and to automatically sort out the logs deemed important for any stage of the operation of the EM tool 58 (i.e., separate channel prioritizations for respective zones of a formation). In other embodiments, one set of output logs can be determined for an entire operation and the EM tool 58 can be setup to transmit only those prioritized logs during operation.

In some embodiments, the actual earth can be different from the prejob model that is generated. Accordingly, in some embodiments, the input values from block 68 (e.g., the formation models of block 68) can be updated in real-time or near real-time to allow for actual formation measurements to be included. Thereafter, the process outlined above with respect to flow chart 66 can be recomputed to generate new results for logs to be transmitted during a particular drilling operation.

The subject matter described in detail above may be defined by one or more clauses, as set forth below.

A system includes a logging tool configured to generate measurements in a well during a drilling operation and transmit a predetermined portion of the measurements and a processing system configured to be coupled to the logging tool, wherein the processing system is configured to calculate which data channels of the logging tool to prioritize as the predetermined portion of the measurements to transmit and transmit a control signal to configure the logging tool to transmit the predetermined portion of the measurements.

The system of the preceding clause, wherein the processing system is further configured to receive at least one input value as a formation model, a well trajectory value, a channel list of the logging tool, or formation measurements received from the logging tool and generate a resolution matrix based upon the at least one input value.

The system of any preceding clause, wherein the processing system is further configured to generate the resolution matrix as indicative of relative importance of each data channel of a set of data channels generated by the logging tool.

The system of any preceding clause, wherein the processing system is further configured to determine which data channel of the set of data channels along a diagonal of the resolution matrix has a smallest value as a selected data channel.

The system of any preceding clause, wherein the processing system is further configured to determine whether the selected data channel has a value less than a predetermined cutoff value.

The system of any preceding clause wherein the processing system is further configured to generate a recomputed resolution matrix without the selected data channel when the value of the selected data channel is determined to be less than the predetermined cutoff value.

The system of any preceding clause, wherein the processing system is further configured to determine whether a number of data channels of the recomputed resolution matrix is less than a telemetry threshold value.

The system of any preceding clause, wherein the processing system is further configured to generate the control signal based upon the recomputed resolution matrix when the number of data channels of the recomputed resolution matrix is determined to be less than the telemetry threshold value.

The system of any preceding clause, wherein the processing system is further configured to determine a pair of data channels in an off-diagonal region of the resolution matrix as having a largest value indicating a largest redundancy between a first data channel and a second data channel of the pair of data channels and to generate a recomputed resolution matrix without the first data channel or the second data channel when the value of an off-diagonal term corresponding to the pair of data channels is determined to be greater than the predetermined cutoff value.

The system of any preceding clause, wherein the processing system is further configured to determine whether a number of data channels of the recomputed resolution matrix is less than a telemetry threshold value.

The system of any preceding clause, wherein the processing system is further configured to generate the control signal based upon the recomputed resolution matrix when the number of data channels of the recomputed resolution matrix is determined to be less than the telemetry threshold value.

A tangible and non-transitory machine readable medium comprising instructions to cause a processing system to calculate which data channels of a logging tool to prioritize as a predetermined portion of measurements to transmit from the logging tool and transmit a control signal to configure the logging tool to transmit the predetermined portion of the measurements during operation.

The tangible and non-transitory machine readable medium of the preceding clause, wherein the instructions further cause the processing system to generate a resolution matrix as indicative of relative importance of each data channel of a set of data channels generated by the logging tool.

The tangible and non-transitory machine readable medium of any preceding clause, wherein the instructions further cause the processing system to determine which data channel of the set of data channels along a diagonal of the resolution matrix has a smallest value as a selected data channel and determine whether the selected data channel has a value less than a predetermined cutoff value.

The tangible and non-transitory machine readable medium of any preceding clause, wherein the instructions further cause the processing system to generate a recomputed resolution matrix without the selected data channel when the value of the selected data channel is determined to be less than the predetermined cutoff value.

The tangible and non-transitory machine readable medium of any preceding clause, wherein the instructions further cause the processing system to determine whether a number of data channels of the recomputed resolution matrix is less than a telemetry threshold value and generate the control signal based upon the recomputed resolution matrix when the number of data channels of the recomputed resolution matrix is determined to be less than the telemetry threshold value.

The tangible and non-transitory machine readable medium of any preceding clause, wherein the instructions further cause the processing system to determine a pair of data channels in an off-diagonal region of the resolution matrix as having a largest value indicating a largest redundancy between a first data channel and a second data channel of the pair of data channels and generate a recomputed resolution matrix without the first data channel or the second data channel when the value of an off-diagonal term corresponding to the pair of data channels is determined to be greater than the predetermined cutoff value.

The tangible and non-transitory machine readable medium of any preceding clause, wherein the instructions further cause the processing system to determine whether a number of data channels of the recomputed resolution matrix is less than a telemetry threshold value and generate the control signal based upon the recomputed resolution matrix when the number of data channels of the recomputed resolution matrix is determined to be less than the telemetry threshold value.

A system includes a processing system configured to calculate which data channels of a logging tool to prioritize as a portion of measurements to use for processing and/or decision making based on a data resolution matrix, data importance, and redundancy.

The system of the preceding clause, wherein the processing system is further configured to calculate which data channels of the logging tool to prioritize for multiple scenarios, wherein each scenario has a different set of measurements corresponding thereto.

The system of any preceding clause, wherein the processing system is further configured to transmit an instruction to the logging tool to switch operation of the logging tool in conjunction with the multiple scenarios to transmit the different set of measurements corresponding to each scenario during operation.

The system of any preceding clause, wherein the processing system is further configured to receive an update on a formation model and/or a drilling condition based on new information acquired during operation and recompute which of the data channels of the logging tool to prioritize as a second portion of measurements to use for processing and/or decision making based on the update on the formation model and/or the drilling condition.

This written description uses examples to disclose the subject matter, including the best mode, and also to enable any person skilled in the art to practice the subject matter, including making and using any devices or systems and performing any incorporated methods. The patentable scope of the subject matter is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
a logging tool configured to generate measurements in a well during a drilling operation and transmit a predetermined portion of the measurements; and
a processing system configured to be coupled to the logging tool, wherein the processing system is configured to calculate which data channels of the logging tool to prioritize as the predetermined portion of the measurements to transmit and transmit a control signal to configure the logging tool to transmit the predetermined portion of the measurements.

2. The system of claim 1, wherein the processing system is further configured to:
receive at least one input value as a formation model, a well trajectory value, a channel list of the logging tool, or formation measurements received from the logging tool; and
generate a resolution matrix based upon the at least one input value.

3. The system of claim 2, wherein the processing system is further configured to generate the resolution matrix as indicative of relative importance of each data channel of a set of data channels generated by the logging tool.

4. The system of claim 3, wherein the processing system is further configured to determine which data channel of the set of data channels along a diagonal of the resolution matrix has a smallest value as a selected data channel.

5. The system of claim 4, wherein the processing system is further configured to determine whether the selected data channel has a value less than a predetermined cutoff value.

6. The system of claim 5, wherein the processing system is further configured to generate a recomputed resolution matrix without the selected data channel when the value of the selected data channel is determined to be less than the predetermined cutoff value.

7. The system of claim 6, wherein the processing system is further configured to determine whether a number of data channels of the recomputed resolution matrix is less than a telemetry threshold value.

8. The system of claim 7, wherein the processing system is further configured to generate the control signal based upon the recomputed resolution matrix when the number of data channels of the recomputed resolution matrix is determined to be less than the telemetry threshold value.

9. The system of claim 5, wherein the processing system is further configured to determine a pair of data channels in an off-diagonal region of the resolution matrix as having a largest value indicating a largest redundancy between a first data channel and a second data channel of the pair of data channels and to generate a recomputed resolution matrix without the first data channel or the second data channel when the value of an off-diagonal term corresponding to the pair of data channels is determined to be greater than the predetermined cutoff value.

10. The system of claim 9, wherein the processing system is further configured to determine whether a number of data channels of the recomputed resolution matrix is less than a telemetry threshold value.

11. The system of claim 10, wherein the processing system is further configured to generate the control signal based upon the recomputed resolution matrix when the number of data channels of the recomputed resolution matrix is determined to be less than the telemetry threshold value.

12. A tangible and non-transitory machine readable medium comprising instructions to cause a processing system to:
calculate which data channels of a logging tool to prioritize as a predetermined portion of measurements to transmit from the logging tool; and
transmit a control signal to configure the logging tool to transmit the predetermined portion of the measurements during operation.

13. The tangible and non-transitory machine readable medium of claim 12, wherein the instructions further cause the processing system to generate a resolution matrix as indicative of relative importance of each data channel of a set of data channels generated by the logging tool.

14. The tangible and non-transitory machine readable medium of claim 13, wherein the instructions further cause the processing system to:
determine which data channel of the set of data channels along a diagonal of the resolution matrix has a smallest value as a selected data channel; and
determine whether the selected data channel has a value less than a predetermined cutoff value.

15. The tangible and non-transitory machine readable medium of claim 14, wherein the instructions further cause the processing system to generate a recomputed resolution matrix without the selected data channel when the value of the selected data channel is determined to be less than the predetermined cutoff value.

16. The tangible and non-transitory machine readable medium of claim 15, wherein the instructions further cause the processing system to:
determine whether a number of data channels of the recomputed resolution matrix is less than a telemetry threshold value; and
generate the control signal based upon the recomputed resolution matrix when the number of data channels of the recomputed resolution matrix is determined to be less than the telemetry threshold value.

17. The tangible and non-transitory machine readable medium of claim 14, wherein the instructions further cause the processing system to:
determine a pair of data channels in an off-diagonal region of the resolution matrix as having a largest value indicating a largest redundancy between a first data channel and a second data channel of the pair of data channels; and
generate a recomputed resolution matrix without the first data channel or the second data channel when the value of an off-diagonal term corresponding to the pair of data channels is determined to be greater than the predetermined cutoff value.

18. The tangible and non-transitory machine readable medium of claim 17, wherein the instructions further cause the processing system to:
determine whether a number of data channels of the recomputed resolution matrix is less than a telemetry threshold value; and
generate the control signal based upon the recomputed resolution matrix when the number of data channels of the recomputed resolution matrix is determined to be less than the telemetry threshold value.

19. A system, comprising:
a processing system configured to calculate which data channels of a logging tool to prioritize as a portion of measurements to use for processing and/or decision making based on a data resolution matrix, data importance, and redundancy.

20. The system of claim 19, wherein the processing system is further configured to calculate which data channels of the logging tool to prioritize for multiple scenarios, wherein each scenario has a different set of measurements corresponding thereto.

21. The system of claim 20, wherein the processing system is further configured to transmit an instruction to the logging tool to switch operation of the logging tool in conjunction with the multiple scenarios to transmit the different set of measurements corresponding to each scenario during operation.

22. The system of claim 19, wherein the processing system is further configured to:
receive an update on a formation model and/or a drilling condition based on new information acquired during operation; and
recompute which of the data channels of the logging tool to prioritize as a second portion of measurements to use for processing and/or decision making based on the update on the formation model and/or the drilling condition.
